(19) United States
(12) Patent Application Publication
(10) Pub. No.: US 2004/0052228 A1
(43) Pub. Date: Mar. 18, 2004

(54) Method and system of frequency and time synchronization of a transceiver to signals received by the transceiver

(76) Inventors: Jose Tellado, Mountain View, CA (US); John Dring, San Jose, CA (US)

Correspondence Address: BLAKELY, SOKOLOFF, TAYLOR & ZAFMAN LLP, 12400 Wilshire Boulevard, Seventh Floor, Los Angeles, CA, 90025, US

(21) Appl. No.: 10/245,261

(22) Filed: Sep. 16, 2002

(51) Int. Cl. H04Q 7/00; H04J 3/06

(52) U.S. Cl. 370/334; 370/350

(57) ABSTRACT

The present invention provides a method and system for synchronizing a receiver. The method includes receiving a plurality of wireless signals that have traveled through at least one of multiple transmitter antennas and multiple receiver antennas. The receiver is time and frequency synchronized to each of the wireless signals based upon joint statistics of the plurality of wireless signals. The joint statistics can be a function of data patterns, time of arrival estimations, frequency offset estimations, phase offset estimations, timing offset estimations, error correction codes, post processing SNR, pre-processing SNR, PER, BER, correlator outputs, delay spread or doppler spread, of each of the plurality of wireless signals.

### FIELD OF THE INVENTION

The invention relates generally to a communications receiver. More particularly, the invention relates to a method and system of frequency and time synchronization of a transceiver to signals received by the transceiver.

### BACKGROUND OF THE INVENTION

Wireless communication systems commonly include information-carrying modulated carrier signals that are wirelessly transmitted from a transmission source (for example, a base transceiver station) to one or more receivers (for example, subscriber units) within an area or region.

A Wireless Channel

FIG. 1 shows modulated carrier signals traveling from a transmitter 110 to a receiver 120 following many different (multiple) transmission paths.

Multipath can include a composition of a primary signal plus duplicate or echoed images caused by reflections of signals off objects between the transmitter and receiver. The receiver may receive the primary signal sent by the transmitter, but also receives secondary signals that are reflected off objects located in the signal path. The reflected signals arrive at the receiver later than the primary signal. Due to this misalignment, the multipath signals can cause intersymbol interference or distortion of the received signal.

The actual received signal can include a combination of a primary and several reflected signals. Because the distance traveled by the original signal is shorter than the reflected signals, the signals are received at different times. The time difference between the first received and the last received signal is called the delay spread and can be as great as several micro-seconds.

The multiple paths traveled by the modulated carrier signal typically results in fading of the modulated carrier signal. Fading causes the modulated carrier signal to attenuate in amplitude when multiple paths subtractively combine.

FIG. 2 shows a multiple-antenna base station 210 that can wirelessly communicate with several multiple-antenna subscriber units 220, 230, 240. The base station 210 and each subscriber unit 220, 230, 240 can include spatially separate antennae.

Spatial Multiplexing

Spatial multiplexing is a transmission technology that exploits multiple antennae at both the base transceiver station and at the subscriber units to increase the bit rate in a wireless radio link with no additional power or bandwidth consumption. Under certain conditions, spatial multiplexing offers a linear increase in spectrum efficiency with the number of antennae. For example, if three antennae are used at the transmitter (base transceiver station) and the receiver (subscriber unit), the stream of possibly coded information symbols is split into three independent substreams. These substreams occupy the same channel of a multiple access protocol. Possible same channel multiple access protocols include a same time slot in a time-division multiple access protocol, a same frequency slot in frequency-division multiple access protocol, a same code sequence in code-division multiple access protocol or a same spatial target location in space-division multiple access protocol. The substreams are applied separately to the transmit antennae and transmitted through a radio channel. Due to the presence of various scattering objects in the environment, each signal experiences multipath propagation.

The composite signals resulting from the transmission are finally captured by an array of receiving antennae with random phase and amplitudes. At the receiver array, a spatial signature of each of the received signals is estimated. Based on the spatial signatures, a signal processing technique is applied to separate the signals, recovering the original substreams.

Communication Diversity

Antenna diversity is a technique used in multiple antenna-based communication system to reduce the effects of multi-path fading. Antenna diversity can be obtained by providing a transmitter and/or a receiver with two or more antennae. Each transmit and receive antenna pair include a transmission channel. The transmission channels fade in a statistically independent manner. Therefore, when one transmission channel is fading due to the destructive effects of multi-path interference, another of the transmission channels is unlikely to be suffering from fading simultaneously. By virtue of the redundancy provided by these independent transmission channels, a receiver can often reduce the detrimental effects of fading.

Transmission signals of a wireless system can include streams of digital bits of information. The digital streams are generally broken up into data segments or data packets of information. FIG. 3 shows a data segment of three different received signals Signal1, Signal2, Signal3). The received signals can include multiple received signals of communication diversity or spatial multiplexing. Each data segment 310, 312, 314 is received at a different time depending upon the transmission antennas, the receiver antennas and transmission signal path of the data segments 310, 312, 314.

Data processing of the data segments 310, 312, 314 by the receiver requires the receiver to be time and frequency synchronized with the received data segments 310, 312, 314.

Time synchronization can be accomplished by including a unique, identifiable signal pattern within the data segments that the receiver can recognize. The receiver can use the unique, identifiable signal pattern for determination of when the data segments 310, 312, 314 begin and end. This aids in the processing of the data segments 310, 312, 314.

However, the data segments 310, 312, 314 of FIG. 3 arrive at the receiver at varied time. Therefore, inclusion of a unique, identifiable signal pattern within the data segments 310, 312, 314 may not necessarily provide the best determination of when the data segments begin and end. Arrow 340 is a potential sampling point by the receiver that might be provided by bit sequence. This can correspond to the reception time of the first data segment 310.

Frequency synchronization can also be accomplished by including the unique, identifiable signal pattern within the data segments 310, 312, 314.

It is desirable to have a method and system for time and frequency synchronization of a receiver to multiple received signals. The method and system should be adaptable for time and frequency synchronization of multiple spatial multiplexed or communication diversity signals.

### SUMMARY OF THE INVENTION

The invention includes a method and system for robust frequency and timing synchronization of a receiver to wireless signals transmitted through a multiple input or multiple output channel.

An embodiment of the invention includes a method of synchronizing a receiver. The method includes receiving a plurality of wireless signals that have traveled through at least one of multiple transmitter antennas and multiple receiver antennas. The receiver is time and frequency synchronized to each of the wireless signals based upon joint statistics of the plurality of wireless signals. The joint statistics can be a function of data patterns, time of arrival estimations, frequency offset estimations, phase offset estimations, timing offset estimations, error correction codes, post processing SNR, pre-processing SNR, PER, BER, correlator outputs, delay spread or doppler spread, of each of the plurality of wireless signals.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless system that includes multiple paths from a system transmitter to a system receiver.

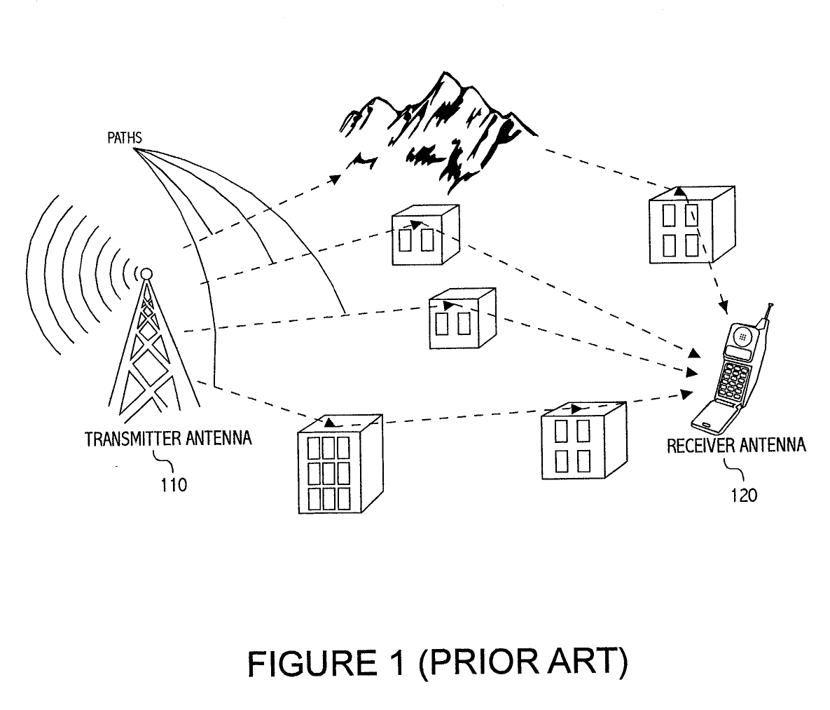

FIG. 2 shows a wireless system that includes multiple transmission antennas and multiple receiver antennas.

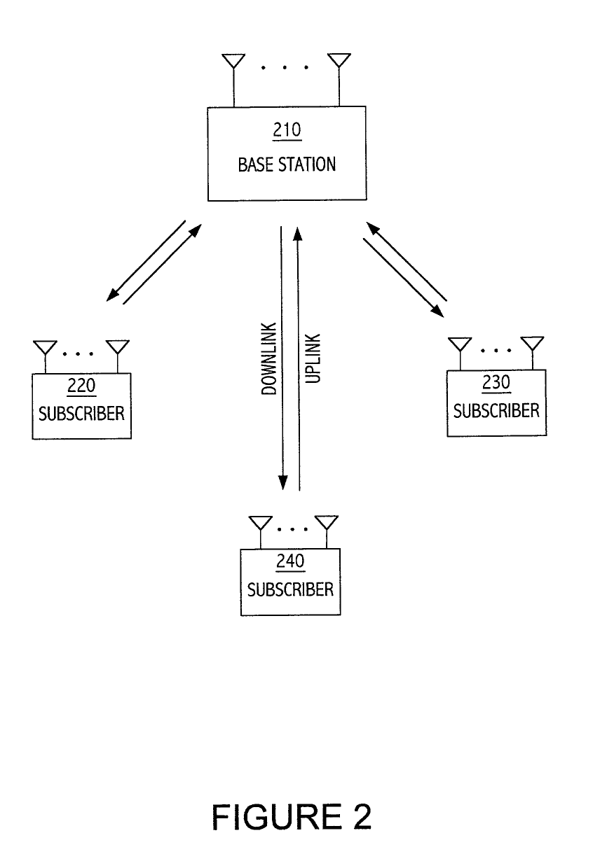

FIG. 3 shows a reception time of data segments of multiple transmission signals.

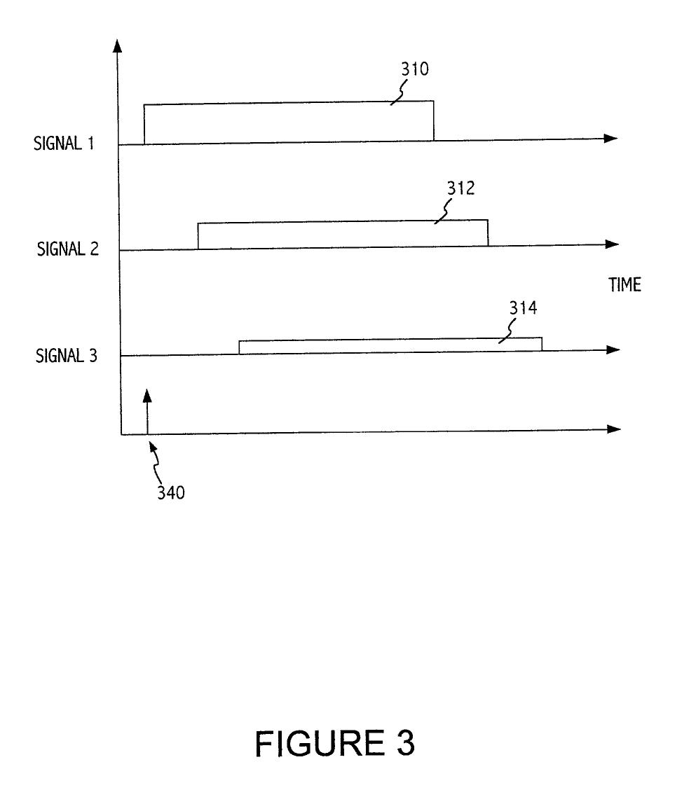

FIG. 4A shows an embodiment of the invention.

FIG. 4B shows another embodiment of the invention that includes multiple receiver chains.

FIG. 5 shows time and frequency controller according to an embodiment of the invention.

FIG. 6 shows multiple time lines of different signals received by an embodiment of the invention.

FIG. 7 shows multiple frequency spectrum of different signals received by an embodiment of the invention.

FIG. 8 shows another embodiment of the invention that includes a receiver chain and a transmitter chain.

FIG. 9 shows another embodiment of the invention that includes multiple transmitter stations.

FIG. 10 shows a flow chart of steps or acts included within an embodiment of the invention.

### DETAILED DESCRIPTION

As shown in the drawings for purposes of illustration, the invention is embodied in a method and system for robust frequency and timing synchronization of a receiver to wireless signals transmitted through a multiple transmit antenna or multiple receiver antenna channel.

Particular embodiments of the present invention will now be described in detail with reference to the drawing figures. The techniques of the present invention may be implemented in various different types of wireless communication systems. Of particular relevance are cellular wireless communication systems. A base station transmits downlink signals over wireless channels to multiple subscribers. In addition, the subscribers transmit uplink signals over the wireless channels to the base station. Thus, for downlink communication the base station is a transmitter and the subscribers are receivers, while for uplink communication the base station is a receiver and the subscribers are transmitters. Subscribers may be mobile or fixed. Exemplary subscribers include devices such as portable telephones, car phones, and stationary receivers such as a wireless modem at a fixed location.

The base station can be provided with multiple antennas that allow antenna diversity techniques and/or spatial multiplexing techniques. In addition, each subscriber can be equipped with multiple antennas that permit further spatial multiplexing and/or antenna diversity. Single Input Multiple Output (SIMO), Multiple Input Single Output (MISO) or Multiple Input Multiple Output (MIMO) configurations are all possible. In either of these configurations, the communications techniques can employ single-carrier or multi-carrier communications techniques. Although the techniques of the present invention apply to point-to-multipoint systems, they are not limited to such systems, but apply to any wireless communication system having at least two devices in wireless communication. Accordingly, for simplicity, the following description will focus on the invention as applied to a single transmitter-receiver pair, even though it is understood that it applies to systems with any number of such pairs.

Point-to-multipoint applications of the invention can include various types of multiple access schemes. Such schemes include, but are not limited to, time division multiple access (TDMA), frequency division multiple access (FDMA), code division multiple access (CDMA), orthogonal frequency division multiple access (OFDMA) and wavelet division multiple access.

The transmission can be time division duplex (TDD). That is, the downlink transmission can occupy the same channel (same transmission frequency) as the uplink transmission, but occur at different times. Alternatively, the transmission can be frequency division duplex (FDD). That is, the downlink transmission can be at a different frequency than the uplink transmission. FDD allows downlink transmission and uplink transmission to occur simultaneously.

Typically, variations of the wireless channels cause uplink and downlink signals to experience fluctuating levels of attenuation, interference, multi-path fading and other deleterious effects. In addition, the presence of multiple signal paths (due to reflections off buildings and other obstacles in the propagation environment) causes variations of channel response over the frequency bandwidth, and these variations may change with time as well. As a result, there are temporal changes in channel communication parameters such as data capacity, spectral efficiency, throughput, and signal quality parameters, e.g., signal-to-interference and noise ratio (SINR), and signal-to-noise ratio (SNR).

Information is transmitted over the wireless channel using one of various possible transmission modes. For the purposes of the present application, a transmission mode is defined to be a particular modulation type and rate, a particular code type and rate, and may also include other controlled aspects of transmission such as the use of antenna diversity or spatial multiplexing. Using a particular transmission mode, data intended for communication over the wireless channel is coded, modulated, and transmitted. Examples of typical coding modes are convolution and block codes, and more particularly, codes known in the art such as Hamming Codes, Cyclic Codes and Reed-Solomon Codes. Examples of typical modulation modes are circular constellations such as BPSK, QPSK, and other m-ary PSK, square constellations such as 4QAM, 16QAM, and other m-ary QAM. Additional popular modulation techniques include GMSK and m-ary FSK. The implementation and use of these various transmission modes in communication systems is well known in the art.

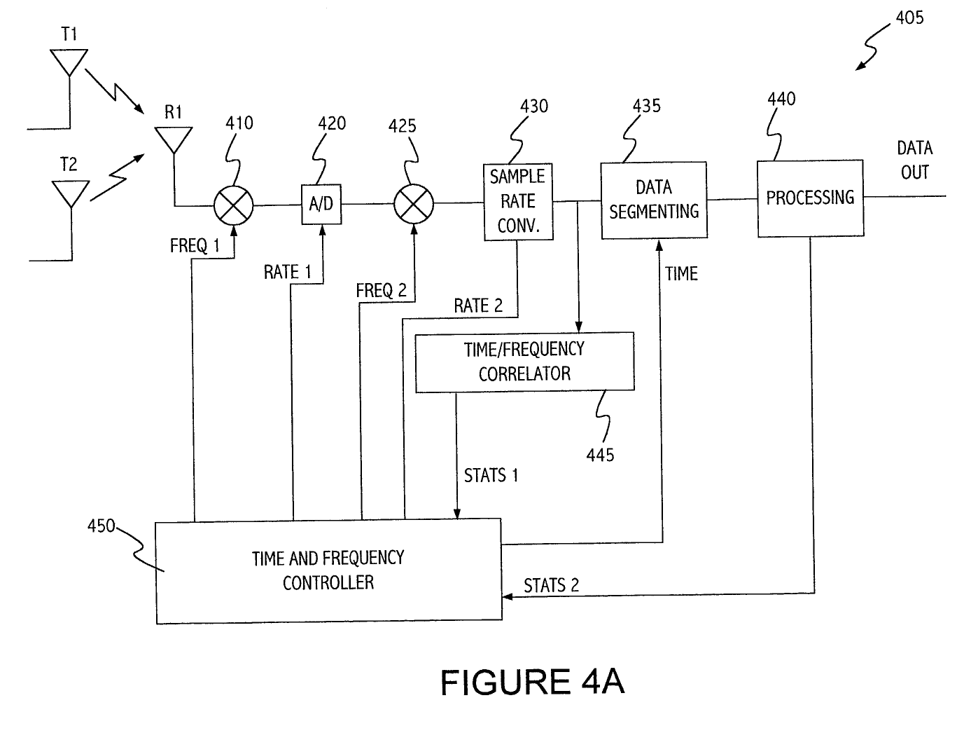

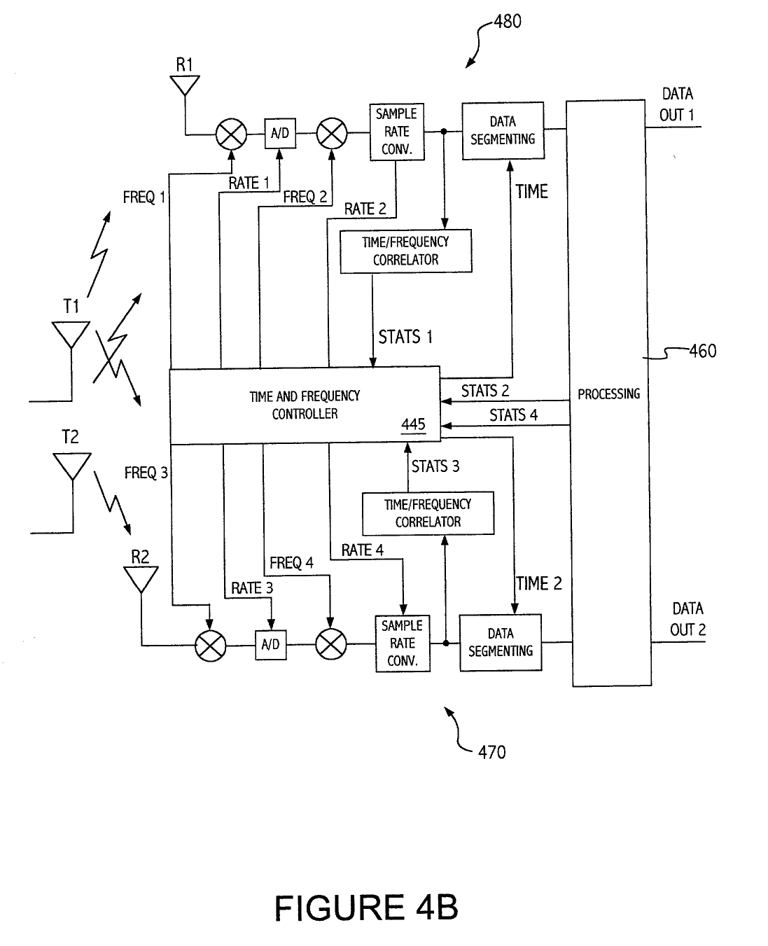

FIG. 4A shows an embodiment of the invention. This embodiment includes a receiver chain 405. The receiver chain 405 generally includes a receiver antenna R1, a first frequency down-converter 410, an analog to digital converter (ADC) 420, a second frequency down-converter 425, a sample rate converter 430, a data segmenter 435, a data processing unit 440, a time/frequency correlator 445 and a time/frequency controller 450.

Generally, the invention includes synchronizing the receiver chain to multiple received signals. The multiple received signals can include wireless signals that have been either transmitter from multiple transmitter antennas or received by multiple receiver antennas. The time and frequency synchronizing of the receiver to each of the wireless signals includes calculating joint statistics of the plurality of wireless signals. That is, the time and frequency synchronization of each of the received signals can be based upon statistics of a combination of several received wireless signals. The joint statistics can be a function of data patterns, time of arrival, frequency offset, timing offset, error correction codes, post processing SNR, pre-processing SNR, PER, BER, delay spread or doppler spread, of the plurality of wireless signals.

The transmission signals received by the receiver antenna R1 generally include digital information (data segments).

The first frequency down-converter 410 is generally a mixer that frequency down-converts the received signal with a local oscillator (LO) signal, generating a base band or low intermediate frequency (IF) signal. The LO signal is typically phase-locked to a reference oscillator within the receiver that is controlled by the time/frequency controller 450.

The ADC 420 converts the analog base band signal to a digital signal consisting of a stream of digital bits. A predetermined number of digital bits make up data segments.

The second frequency down-converter 425 represents a digital frequency down conversion that can take place after the received signals have been digitized by the ADC 420. The second frequency down-converter 425 generates a base band or low intermediate frequency (IF) signal.

The sample rate converter 430 performs a digital re-sampling of the incoming digital samples so-that the output samples are generated at a rate similar to the rate of the transmitter.

A data segmenting unit 435 controls the segmentation of the stream of received digital samples. Generally, the segment controller initially segments the stream of data samples. The initial segmentation can be based upon a segmentation process as previously described. More specifically, the initial segmentation can be based upon the detection of a unique structure within the stream of data samples. The unique structure can be a known pattern of samples. However, as previously described, the processing of the data samples can be difficult in multi-path environments because the receiver receives several versions of the transmitted signals at different points in time.

A processor 440 processes the received streams of digital samples. Generally, the processing includes demodulating and decoding the bit stream to yield an estimated received data stream.

The time/frequency correlator 445 generates statistics (Stats1) from the received signals that are used by the time/frequency controller 450 to generate the sampling time, frequency and rate estimates. Statistics of the received signals that can be generated by the time/frequency correlator 445 include time of arrival estimates and frequency and phase offset estimates. Other estimates can also be generated, such as, signal power and noise level.

The time of arrival estimates can be generated by correlating the received signals with patterns that have been included within data of the received signals before the received signals were transmitted. Determination of the maximum correlation allows for a determination of the time of arrival.

Frequency and phase offsets can be determined by correlating the received signals with delayed versions of the received signals, and monitoring the phase differences.

The processor 440 performs additional processing of the received signals. The processor 440 can generate additional statistics (Stats2) that can also be used by the time/frequency controller 445. Statistics that can be generated include receiver equalizer settings, receiver signal SNR calculations, constellation errors and FEC (forward error correction) metrics. Other statistics can include frequency, time and phase estimates.

FIG. 4B shows another embodiment of the invention that includes multiple receiver chains 470, 480. The elements of the receiver chains 470, 480 are essentially the same as the elements of the receiver chain 405 of FIG. 4A. The time/frequency controller 445 generates additional time (Time2), frequency (Freq3, Freq4) and rate (Rate3, Rate4) controls for the additional receiver chain 470. The time/frequency controller receives additional statistics (Stats3, Stats4) from the additional receiver chain 470. A joint processor 460 processes the received data streams of the receiver chains 470, 480. The embodiment of FIG. 4B is merely an example of a multiple receiver chain. Additional receiver chains can be included.

The above described statistics (Stats1, Stats2) are received by the time/frequency controller 445. For SIMO, MISO and MIMO channel situations, each of the statistics can include different parameters for each transmitter antenna, receiver antenna pair. The result being statistics that are vectors representing all of the transmitter antenna, receiver antenna pairs. Frequency, time and rate estimates generated bases upon the statistic vectors provide joint estimates in which the frequency, time and rate estimates generated for each transmitter antenna, receiver antenna pair are influenced by individual estimates for each transmitter antenna, receiver antenna pair. The joint estimates are generally more accurate than the individual estimates.

The embodiments of FIGS. 4A, 4B shows two transmission antennas. It is to be understood that this is merely an example. That is, any number of transmission antennas can be included.

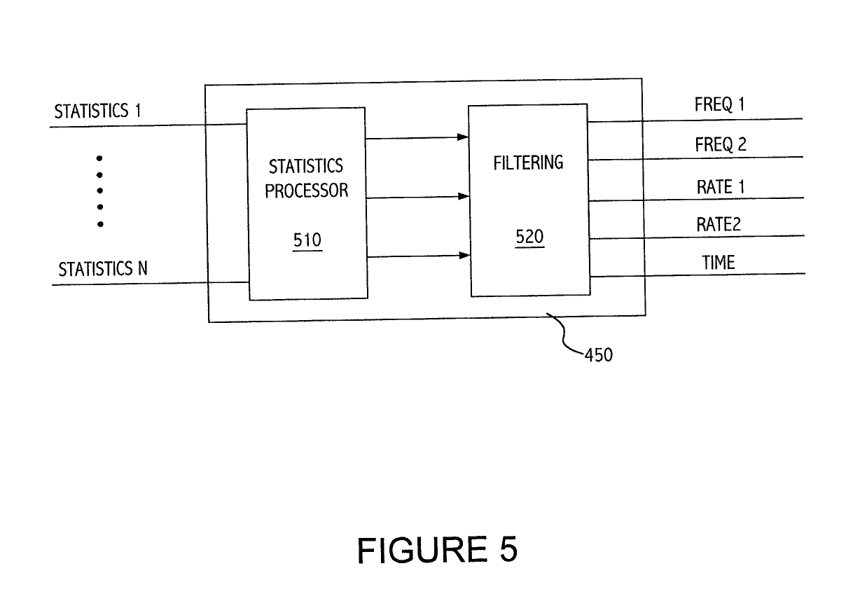

FIG. 5 shows the time and frequency controller 450 according to an embodiment of the invention. The time and frequency controller 450 includes a statistics processor 510 and filtering unit 520. The time and frequency controller 450 receives statistics (statistics1-statisticsN) that are used to generate frequency and timing control of the receiver chain 405. The statistics (statistics1-statisticsN) can include the elements of the vectors of Stats1 and Stats2, and even the vector elements of Stats3 and Stats4 for multiple receiver chains. That is, each element of the statistics (statistics1-statisticsN) can correspond to an element of the vectors Stats1, Stats2, Stats3 and Stats4.

The filtering unit 520 can be used to filter or average the outputs of the statistics processor 510. Generally, the averaging is over time. The filtering unit outputs include Freq 1, Freq2, Rate 1, Rate2 and Time, which are used to frequency, rate and time synchronize the receiver chain 405 to the received signals. typically, the filtering includes first and/or second order filters.

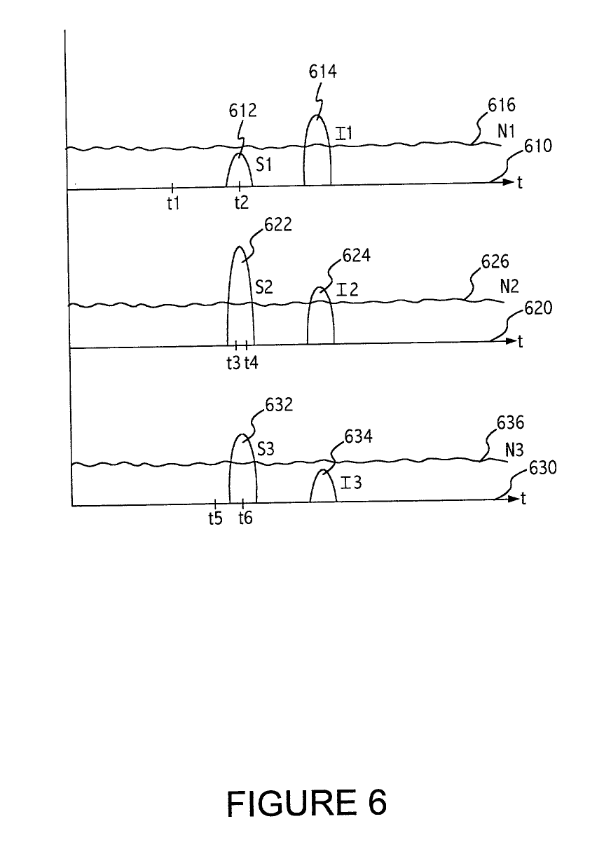

The statistics processor 510 receives the statistics (statistics1-statisticsN) and processes them, aiding in generation of the time and frequency controls. The statistics (statistics1-statisticsN) received, and the processing of the statistics (statistics1-statisticsN) can be more readily understood by referring to FIG. 6 and the associated description.

FIG. 6 shows time lines of signals received by three different receiver chains. Generally, each receiver time line includes a desired signal, an interference signal and a noise floor.

A first time line 610 of a first receiver chain includes a desired signal (S1) 612, an interference signal (I1) 614, and a noise floor (N1) 616. Here, the desired signal 612 has an amplitude that is less than the interference signal 614 and the noise floor 616. Determining optimal time and frequency synchronization for the desired signal 612 is nearly impossible, because the desired signal 612 is dominated by the interference signal 614 and the noise floor 616. For example, a timing synchronization estimate for the first receiver chain based upon the received signals may be t1, whereas the optimal timing synchronization is more likely to be t2.

A second time line 620 of a second receiver chain includes a desired signal (S2) 622, an interference signal (I2) 624, and a noise floor (N2) 626. Here, the desired signal 622 has an amplitude that is greater than the interference signal 624 and the noise floor 626. Determining optimal time and frequency synchronization for the desired signal 622 is easier than for the first receiver chain because the desired signal 622 is not dominated by the interference signal 624 and the noise floor 626. A timing synchronization estimate for the second receiver chain based upon the received signals may be t3, whereas the optimal timing synchronization may be t4.

A third time line 630 of a third receiver chain includes a desired signal (S3) 632, an interference signal (I3) 634, and a noise floor (N3) 636. Here, the desired signal 632 has an amplitude that is greater than the interference signal 634 and the noise floor 636. Determining optimal time and frequency synchronization for the desired signal 632 is easier than for the first receiver chain because the desired signal 632 is not dominated by the interference signal 634 and the noise floor 636. The amplitude of the desired signal (S3) 632 is not as great as the amplitude of the desired signal (S2) 622. A timing synchronization estimate for the third receiver chain based upon the received signals may be t5, whereas the optimal timing synchronization may be t6.

The statistics (statistics1-statisticsN) received by the statistics processor 610 can include the sampled S1, S2, S3 signals. Timing and frequency synchronization estimates can be generated by the statistics.

Proper data timing synchronization provides maximal desired processed signal energy while minimizing the degradation effects of noise, distortion and interference. To maximize the quality of the received and processed signal, the desired signals must be extracted from the unwanted interference and noise. Extraction can be accomplished in many different ways, but generally depends heavily upon the specific modulation and receive configuration used.

An embodiment includes using timing and frequency synchronization estimates of each receiver chain for a determination of a joint timing and a joint frequency synchronization estimate. The joint estimate can be used for each individual receiver chain. For example, the estimates t1, t3, t5 from the above description may be combined to generate a vector joint estimate. The vector joint estimate can be used to generate timing estimate for each receiver chain.

Generally, timing phase estimators will select a timing synchronization based upon a simple selection criteria, such as maximal signal energy peak of the received signal. However, the segmentation point will generally be erroneous due to multi-path fading of the desired signal, undesired distortion of the desired signal, interference and noise.

The above described vector joint estimate can provide a more accurate estimate of the true timing phase values. For example, the second receiver has a much stronger desired signal strength to distortion value than the first receiver, and provides a much more accurate timing synchronization estimate t3, than the timing synchronization estimate t1 of the first receiver.

The joint timing synchronization estimates can be calculated by combining the individual estimates according to a weighting scheme. For example, the weighted contribution of each individual estimate to the joint estimate can be determined by an estimated SNR of the received signal that correspond with each individual estimate. More generally, a quality parameter of each received signal can be used to determine a weight the corresponding estimate of each received signal has upon the joint estimates. In the example provided above, the estimate corresponding with the sampled S2 signal would have the greatest weight because the received S2 signal has the greatest SNR. The estimate corresponding with the sampled S1 signal would have the smallest weight because the received S1 signal has the smallest SNR.

The weighting can be dependent upon other signal parameters as well. For example, the weighting can be dependent upon the received signal delay spread, delay profile, doppler rate, BER or error rates. This is not an exhaustive list. An combination of these or other signal parameters can be used to determine the weighted contributions of the individual estimates.

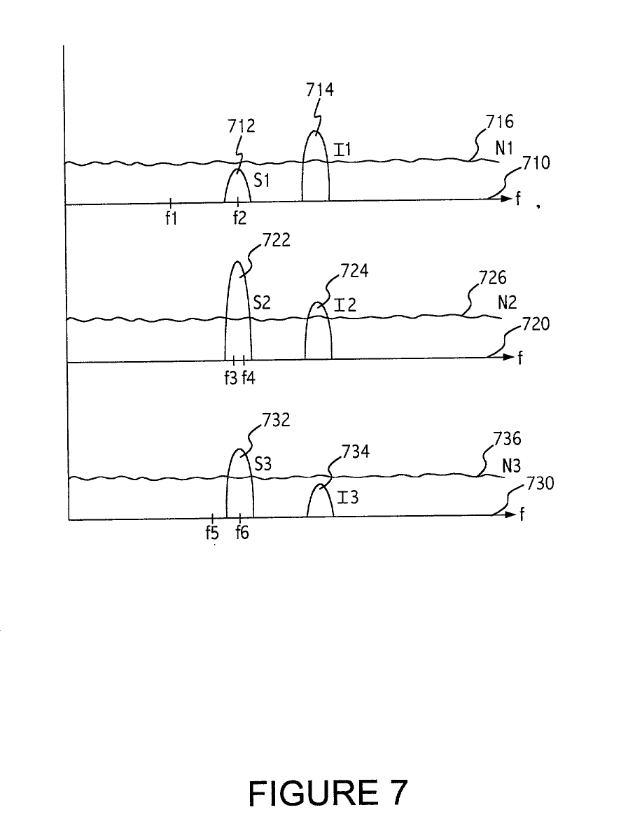

FIG. 7 provides an analogous analysis in the frequency domain as the time domain analysis of FIG. 6. FIG. 7 shows frequency spectrums of signals received by three different receiver chains. Generally, each receiver time line includes a desired signal, an interference signal and a noise floor.

A first frequency spectrum 710 of a first receiver chain includes a desired signal (S1) 712, an interference signal (I1) 714, and a noise floor (N1) 716. Here, the desired signal 712 has an amplitude that is less than the interference signal 714 and the noise floor 716. Determining optimal time and frequency synchronization for the desired signal 712 is nearly impossible, because the desired signal 712 is dominated by the interference signal 714 and the noise floor 716. For example, a frequency synchronization estimate for the first receiver chain based upon the received signals may be f1, whereas the optimal frequency synchronization is more likely to be f2.

A second frequency spectrum 720 of a second receiver chain includes a desired signal (S2) 722, an interference signal (I2) 724, and a noise floor (N2) 726. Here, the desired signal 722 has an amplitude that is greater than the interference signal 724 and the noise floor 726. Determining optimal time and frequency synchronization for the desired signal 722 is easier than for the first receiver chain because the desired signal 722 is not dominated by the interference signal 724 and the noise floor 726. A frequency synchronization estimate for the second receiver chain based upon the received signals may be f3, whereas the optimal frequency synchronization may be f4.

A third frequency spectrum 730 of a third receiver chain includes a desired signal (S3) 732, an interference signal (I3) 734, and a noise floor (N3) 736. Here, the desired signal 732 has an amplitude that is greater than the interference signal 734 and the noise floor 736. Determining optimal time and frequency synchronization for the desired signal 732 is easier than for the first receiver chain because the desired signal 732 is not dominated by the interference signal 734 and the noise floor 736. A frequency synchronization estimate for the second receiver chain based upon the received signals may be f5, whereas the optimal frequency synchronization may be f6.

The statistics (statistics1-statisticsN) received by the statistics processor 610 can include the sampled S1, S2, S3 signals. Timing and frequency synchronization estimates can be generated by the statistics.

Individual signal frequency estimates can be generated by observing phase differences of known data patterns embedded within the received data.

The above described vector joint estimate can provide a more accurate estimate of the true frequency synchronization values. For example, the second receiver has a much stronger desired signal strength to distortion value than the first receiver, and provides a much more accurate frequency synchronization estimate f3, than the frequency synchronization estimate f1 of the first receiver.

The joint frequency synchronization estimates can be calculated by combining the individual estimates according to a weighting scheme. For example, the weighted contribution of each individual estimate to the joint estimate can be determined by an estimated SNR of the received signal that correspond with each individual estimate. In the example provided above, the estimate corresponding with the sampled S2 signal would have the greatest weight because the received S2 signal has the greatest SNR. The estimate corresponding with the sampled S1 signal would have the smallest weight because the received S1 signal has the smallest SNR.

The weighting can be dependent upon other signal parameters as well. For example, the weighting can be dependent upon the received signal delay spread, delay profile, doppler rate, BER or error rates. This is not an exhaustive list. An combination of these or other signal parameters can be used to determine the weighted contributions of the individual estimates.

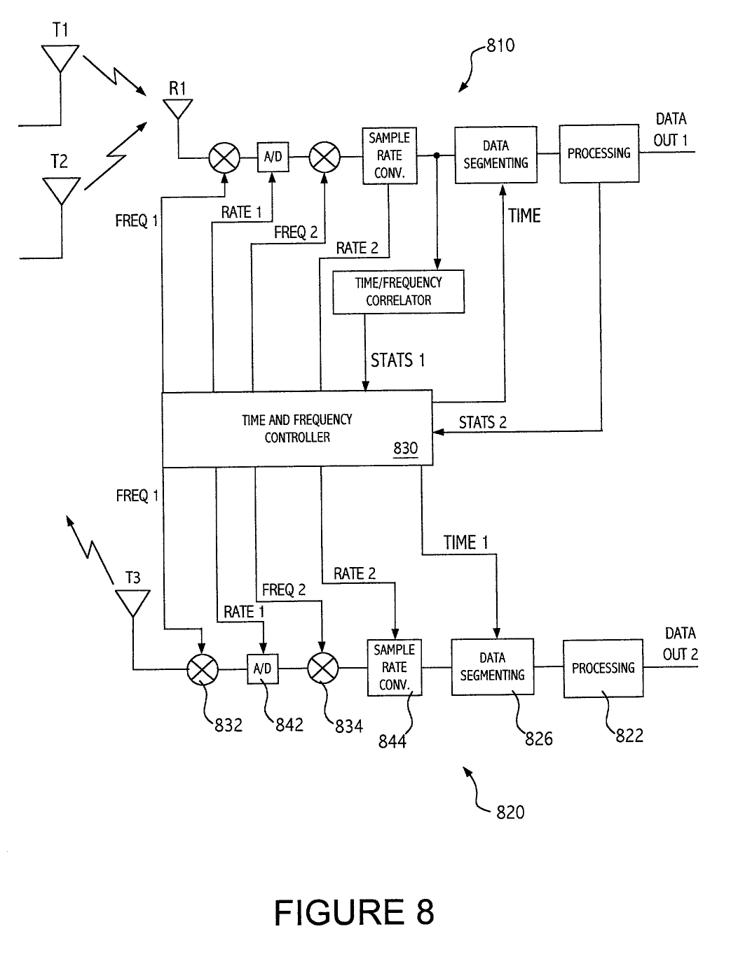

FIG. 8 shows an embodiment of the invention that includes a receiving chain 810 and a transmission chain 820.

The transmission chain 820 receives a stream of data (DATA IN) for transmission. A processing unit 822 processes the received data stream. The processing can include coding, spatial processing and/or diversity processing.

A segmenting unit 826 provides control over segmenting the data stream before transmission.

A time and frequency controller 830 provides the frequency controls (Freq1, Freq2) for two possible frequency up converters 832, 834. The time and frequency controller 830 provides rate controls (Rate1, Rate2) for a transmission ADC(s) 842, 844. The time and frequency controller 830 provides timing control (Time) for the segmenting unit 826.

The embodiment of FIG. 8 provides frequency, rate and time synchronization for up link communication. This synchronization can be useful because the joint estimates generated by down link reception can provide for accurate frequency, rate and time synchronization. A base station receiving signals transmitted from the transmission chain 820 may properly synchronize with the transmitted signals.

Multiple Base Station Spatial Multiplexing

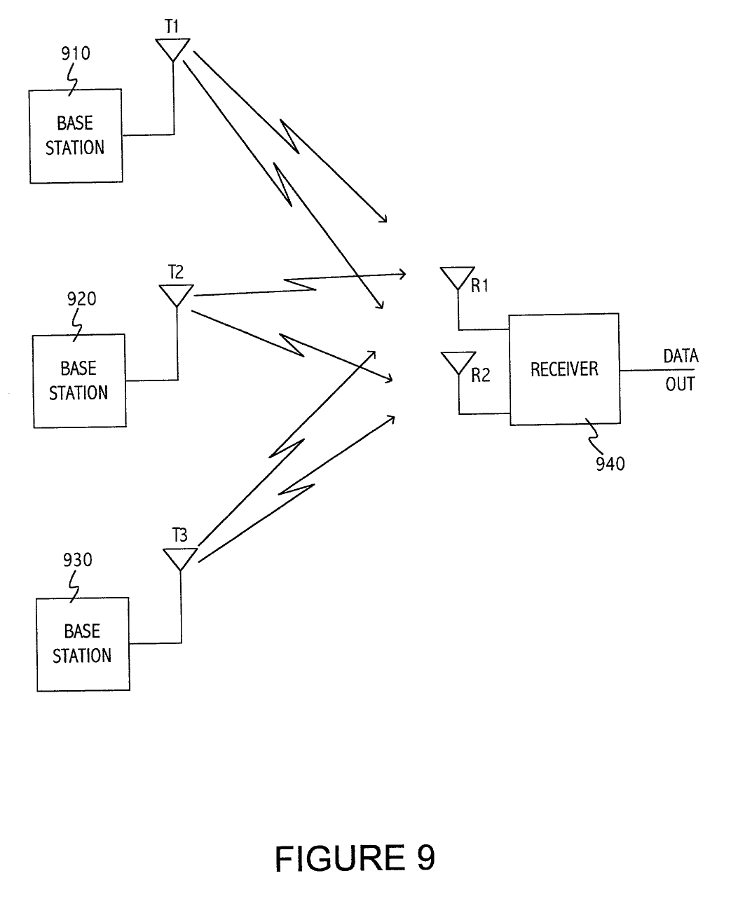

FIG. 9 shows an embodiment of the invention that includes multiple transmitting base stations 910, 920, 930. Each of the transmitting base stations 910, 920, 930 can include a corresponding transmit antenna T1, T2, T3. Each of the transmitting base stations 910, 920, 930 can transmit information to a receiver 940. The receiver can include multiple receiver antennae R1, R2. The invention can include any number of transmit and receive antennae.

The multiple transmitting base stations 910, 920, 930 can include spatial multiplexing transmission of diversity transmission. Because the transmitting base stations 910, 920, 930 are physically separated from each other, each of the transmission paths can be very different.

Each receiver chain of the receiver 940 can include the frequency, timing and rate synchronization of the invention.

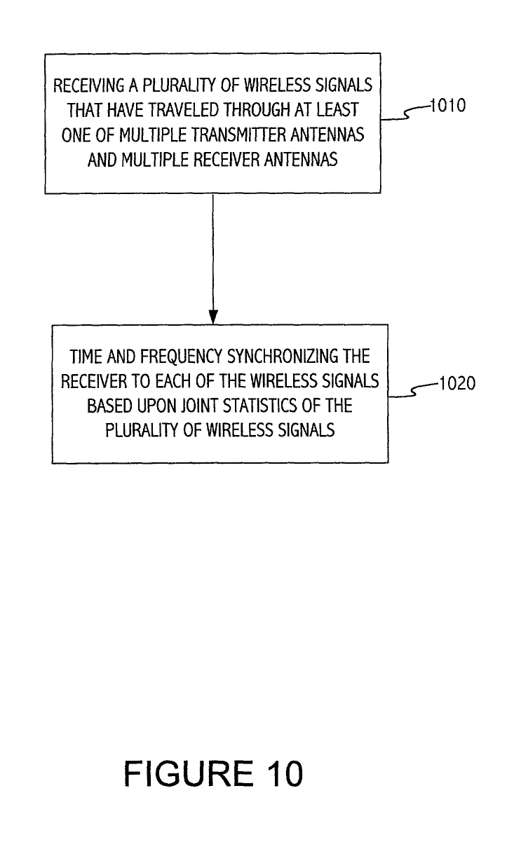

FIG. 10 shows a flow chart of steps or acts included within an embodiment of the invention. This embodiment includes method of time and frequency synchronizing a receiver.

A first step 1010 includes receiving a plurality of wireless signals that have traveled through at least one of multiple transmitter antennas and multiple receiver antennas.

A second step 1020 includes time and frequency synchronizing the receiver to each of the wireless signals based upon joint statistics of the plurality of wireless signals.

Although specific embodiments of the invention have been described and illustrated, the invention is not to be limited to the specific forms or arrangements of parts so described and illustrated. The invention is limited only by the claims.

What is claimed:

1. A method of synchronizing a receiver, comprising:
receiving a plurality of wireless signals that have traveled through at least one of multiple transmitter antennas and multiple receiver antennas; and
time and frequency synchronizing the receiver to each of the wireless signals based upon joint statistics of the plurality of wireless signals.

2. The method of frequency and time synchronization of a receiver to signals received by the receiver of claim 1, wherein the joint statistics of the plurality of wireless signals is a function of at least one of data patterns, time of arrival, frequency offset, timing offset, error correction codes, post processing SNR, pre-processing SNR, PER, BER, delay spread and doppler spread, of each of individual wireless signals received.

3. The method of frequency and time synchronization of a receiver to signals received by the receiver of claim 1, wherein the joint statistics comprise a sum of weighted values of individual statistics from each of individual received wireless signals.

4. The method of frequency and time synchronization of a receiver to signals received by the receiver of claim 3, wherein the weighted value of each individual statistic can vary depending upon a quality parameter of the corresponding individual received wireless signal.

5. The method of frequency and time synchronization of a receiver to signals received by the receiver of claim 3, wherein the weighted value of each individual statistic is dependent upon a signal strength relative to noise, distortion and interference of a corresponding received wireless signal.

6. The method of frequency and time synchronization of a receiver to signals received by the receiver of claim 1, wherein:
each wireless signal is received through a corresponding receiver chain of the receiver.

7. The method of frequency and time synchronization of a receiver to signals received by the receiver of claim 1, wherein each received wireless signal is separable from all the other received wireless signals.

8. The method of frequency and time synchronization of a receiver to signals received by the receiver of claim 1, wherein:
each wireless signal is received from a corresponding transmitter chain.

9. The method of frequency and time synchronization of a receiver to signals received by the receiver of claim 8, wherein:
each of the corresponding transmitter chains are located within a single transmitter.

10. The method of frequency and time synchronization of a receiver to signals received by the receiver of claim 8, wherein:
each of the corresponding transmitter chains are located at a separate transmitter.

11. A method of synchronizing a receiver, comprising:
receiving a plurality of wireless signals transmitted from multiple transmitter antennas; and
time and frequency synchronizing the receiver to each of the wireless signals based upon joint statistics of the plurality of wireless signals, the joint statistics comprising individual statistic of each of individually received wireless signals.

12. The method of frequency and time synchronization of a receiver to signals received by the receiver of claim 11, wherein:
each of the corresponding transmitter chains are located within a single transmitter.

13. The method of frequency and time synchronization of a receiver to signals received by the receiver of claim 11, wherein:
each of the corresponding transmitter chains are located a separate transmitters.

14. A method of synchronizing a receiver, comprising:
receiving a plurality of wireless signals that have traveled through multiple receiver antennas; and
time and frequency synchronizing the receiver to each of the wireless signals based upon joint statistics of the plurality of wireless signals, the joint statistics comprising individual statistic of each of individually received wireless signals.

15. A synchronized receiver, comprising:
a frequency down converter for frequency down converting a plurality of received signals;
an ADC for digitizing the frequency down converted received signals;
a data stream segmenter receiving the digitizing the frequency down converted received signals and generating data stream segments;
a data processing unit receiving the data stream segments and generating a data out stream, and data statistics for each of the received signals;
a time/frequency controller receiving the data statistics, the time/frequency controller generating time a frequency controls of the frequency down-converter, the ADC and the data stream segmenter based upon joint summations of the data statistics.

16. The synchronized receiver of claim 15, wherein the joint summations comprises summing weighted values of the data statistics, each weighted value being dependent upon the received signal corresponding with each data statistic.

17. The synchronized receiver of claim 15, wherein each received signal corresponds with a separate transmitter antenna.

18. The synchronized receiver of claim 15, wherein each received signal corresponds with a separate receiver antenna.

19. The synchronized receiver of claim 15, wherein the weighted value of each individual data statistic can vary depending upon a quality parameter of the corresponding individual received wireless signal.

20. The synchronized receiver of claim 19, wherein the quality parameter of each individual received wireless signal is dependent upon a signal level of the individual received wireless signal relative to noise, interference and distortion.
